(19) United States
(12) Patent Application Publication
(10) Pub. No.: US 2023/0335984 A1
(43) Pub. Date: Oct. 19, 2023

(54) MULTI-FUNCTION NON-ELECTRIC SHOCK PROTECTION SYSTEM AND METHOD THEREOF

(71) Applicant: Enerpark Co.,Ltd, Gwangmyeong-si Gyeonggi-do (KR)

(72) Inventors: Jong Hoo Park, Yongin-si Gyeonggi-do (KR); Ho Jin Jeong, Gwangmyeong-si Gyeonggi-do (KR); Gu Bok Cho, Yongin-si Gyeonggi-do (KR)

(21) Appl. No.: 18/014,036

(22) PCT Filed: Jul. 6, 2020
(86) PCT No.: PCT/KR2020/008779

§ 371 Date: Dec. 30, 2022

(51) Int. Cl. H02H 3/10; H02H 3/04

(52) U.S. Cl. CPC H02H 3/105; H02H 3/04

(57) ABSTRACT

A non-electric shock protection system and method thereof for preventing an electric shock caused by shielding, absorption, and reduction of a leakage current, and preventing an arc by blocking an external surge. The system includes a multi-functional ground fault portion for leakage current shielding and ground distribution, a noise filter portion for shielding, absorbing and reducing a leakage current at a power terminal L and a neutral line terminal N, a power portion for supplying a power, a main control portion for controlling each portion of the system to output a normal power and control an amount of a leakage current, an abnormal current sensing portion for collecting the abnormal leakage currents and noise current, a pulse width modulation control portion for receiving a power from the abnormal current sensing portion and compensating the power through the amplitude and frequency modulation and a polarity indicating portion

### TECHNICAL FIELD

The invention is related to providing a non-electric shock prevention apparatus for preventing the short circuit due to leakage currents from being introduced into a system, and particularly, to providing a multi-functional non-electric shock protection system and a method thereof for cutting off, shielding, absorbing and reducing leakage currents to protect the non-electric shock and for sensing abnormal states of a power applied to an electric device and compensating frequencies to block up an outside serge in an arrangement mode utilizing a wave band caused by an equal electric potential phenomenon of each phase interval with the electric device being exposed to various external environments.

### BACKGROUND OF INVENTION

A typical conventional art is Korea Patent No. 10-1915485 filed on Nov. 11, 2018, which is disclosed as

a title “Grounded non-electric shock prevention apparatus”. The prior art discloses an input terminal portion100 including a first input terminal 110 electrically connected to any one of a phase voltage terminal and a neutral point terminal, a second input terminal 120 connected to any terminal not electrically connected and a ground terminal G grounded; a terminal polarity fixing portion 200 including a switching portion 210, a switching control portion 220, a SMPS portion 230 and a second power connecting portion 240; an output terminal portion 300 including a first output terminal 310, a second output terminal 320 and a neutral point output terminal 330, in which the terminal polarity fixing portion 200 is positioned between the first input terminal portion 100 and the output terminal portion 300 to electrically connect each of the first input terminal 110 and the second input terminal 120 to the first output terminal 210 and the second output terminal 230, any one of the first output terminal 210 and the second output terminal 230 is electrically connected to the phase voltage terminal and the neutral point output terminal 330 is electrically connected to the neutral point terminal; a connection terminal portion 400 including a first connection terminal 410, a second connection terminal 420 and a neutral point output terminal 430, which are provided with a body portion made of an insultation material to electrically connect each of the first output terminal 310, the second output terminal 320 and the neutral point output terminal 330 to a load; and a shock circuit prevention conductor portion 500 including a vertical conductor part penetrating downward through a body from the neutral point connection terminal 430 to be disposed on the peripheral part of a connection terminal electrically connected to a phase voltage terminal, so that if any one of the first output terminal 310 and the second output terminal 320 is electrically connected to the phase voltage terminal, the connection terminal connected to the phase voltage connection terminal is not electrically connected and the neutral point connection terminal 430 connected to the neutral terminal is electrically connected, a vertical conductor part penetrated in the low part from the neutral point connection terminal 430 to be arranged around the surrounds of the connection terminal that is electrically connected to the phase voltage, a bottom conductor part horizontally inflected from the end of the vertical conductor part and extended outward crossing a bottom of the body and a plate type of a side conductor part inflected upward from the end of the bottom conductor part and extended to a height to be less low over the upper surface of a connection terminal block facing the side of the body.

As described above, the prior art entitled “Korea Registration Patent No. 10-1197414” discloses “Apparatus for protecting an electric leakage when filled with water” resolving problems causing an energy loss and heat generation based on a resistor value of a switching portion due to it that voltage and current capacities of a power line are limited to ones of the switching portion with input terminals being connected through a switching portion to output terminals. For it, the input terminals are directly connected to the output terminals so that the voltage and current capacities of the power line are not limited to ones of the switching portion. The voltage and current capacities of the power input load are simultaneously applied to output terminal portions to be provided. Even if the terminals exposed from an electric device are waterlogged, leakage currents flowing between the terminals are reduced to prevent an electric shock and secure or enable the normal operation of the electric device, and an electric electromagnetic wave generated from the outside is reduced to decrease the exposure of an inner circuit in the electric device.

But the prior art discloses a configuration in that a single polarity fixing portion between an input terminal and an output terminal energizes a relay coil of a switching portion to apply a phase voltage to a load, includes a power connection portion preventing the short circuit and connection terminals connected to the load, in which the connection terminals are spaced away and insulated from each another in an insulation body and a short circuit prevention conductor portion includes vertical, horizontal and side conductor parts supporting the connection terminals and facing a body part made of usually a metal or copper plate material.

The prior art has disadvantages in that the switching portion shields the electric force line and prevents the short circuit but has concerns of an error operation due to the instantaneous high voltage and high current, the short circuit prevention conductor portion cannot avoid the occurrence of the electric force field dependent upon the separation distance between a phase voltage terminal and an ground terminal and also the electric shock due to the loss of its function at over a certain amount of leakage currents, and an metal plate, for example an electric copper plate, cannot perform the function of its ability due to a long term’s use and/or a small damage because a simple shielding of the electric power line to be a primary cause of leakage currents by a contact air and humidity as well as the leakage current sharply raised up at a certain time point causes the electric shock to a human body.

Also. the prior art has a disadvantage in that an amount of leakage currents is increased in proportion to the capacity of a load due to it that the system is connected in series with the electric device.

Considering these points described above, the prior art doesn’t absorb and shield over a certain amount of leakage currents dependent on the simple electromagnetic field shielding effect only. Therefore, it is very preferable if the additional shielding, absorbing and reducing of leakage currents are required, an error operation of various electric devices is prevented, an abnormal voltage to be applied to a system circuit is detected to prevent a short circuit of an electric device upon a power application and it is possible to enable the power application in a waterlogged and humidified areas and the short circuit due to the leakage current is prevented.

### DETAILED DESCRIPTION OF INVENTION

### Technical Task

A main object of the invention is to provide a multi-functional non-electric shock protection system and a method thereof for capturing, shielding, absorbing and reducing leakage currents to prevent the non-electric shock on human beings and for sensing applied abnormal states and compensating frequencies to block an outside serge so that an electric device applied the power thereto and maintained into the ground state converts the frequency into a sinusoidal band with constant external interference-free amplitudes without interferences from various outside environments and makes electric power lines in an electro arrangement to be “Zero Potentialization” without any potential difference between each equipotential as well as prevent the formation of abnormal waveforms due to harmonious waves and noises.

The other object of the invention is to provide a multi-functional non-electric shock protection system and a method thereof for sensing the abnormal state applied and compensating for frequencies so that a leakage current of the electric device is cut off without external disturbance and noises and electric electromagnetic waves are significantly reduced based on the modulation compensation control in order to prevent the malfunction and the damage of components as well as to sense/detect the occurrence of overvoltage thereby to trip a short circuit interrupter on an electric distribution board.

Another object of the invention is to provide a multi-functional non-electric shock protection system and a method thereof for sensing the abnormal state applied and compensating for a frequency so that a short circuit is sensed and blocked on a circuit without a structure for avoiding the malfunctions related to the absorption(annihilation) of the electric field and the shielding of over a certain amount of leakage currents and the power is applied in a stable manner to a load even upon flooding.

### MEANS OF SUBJECT SOLUTION

According to the invention, a multi-functional non-electric shock protection system comprises a multi-functional ground fault interruption portion for detecting an abnormal state a power applied and performing a ground fault current shielding and ground distribution; and, a multi-functional non-electric shock protection portion including a noise filter portion including a filter connected between a power terminal L and a neutral terminal N for shielding, absorbing(annihilating) and reducing a leakage current, a power portion supplying a power of a system, a main control portion controlling respective portions of the system to maintain an amount of a leakage current within 5mA in any situation in order to output a normal power, an abnormal current sensing portion for collecting the abnormal leakage currents and noise currents upon the abnormal current sensing of the main control portion as a use power; a pulse width modulation control portion for receiving a power from the abnormal current sensing portion and compensating the power through the amplitude and frequency modulation and a polarity indicating portion for sensing a polarity error of an input power and indicating it, for capturing, shielding, absorbing and reducing leakage currents to prevent the non-electric shock on human beings and senses applied abnormal states and compensates frequencies in order to block an external serge, so that an electric device applied the power thereto and maintained into a ground state converts the frequency into a sinusoidal band with constant external interference-free amplitudes without interferences from various outside environments and makes electric power lines in an electro arrangement to be “Zero Potentialization” without any potential difference between each equipotential as well as prevent the formation of abnormal waveforms due to harmonious waves and noises.

The multi-functional ground fault interruption portion includes a relay provided with a relay coil and a first and second switches, in which the relay coil is connected at a port 2′ to a power terminal L and at a port 1′ to a neutral terminal N, a first diode, a first LED and a first resistor connected in series between port 1′ and port 2′, the relay includes a first switch and a second switch, ports 4′ and 8′ of which are connected through a second resistor in common to a load terminal E2, a first bridge circuit includes rectification input ports each connected to the port 3′ of the first switch and the port 6′ of the second switch and output ports connected to a first neon lamp and a second neon lamp arranged in parallel, the port 3′ of the first switch is connected to a load ground terminal E1, and the port 6′ of the second switch is connected in series to a third neon lamp and a third resistor and then and the port 3′ of the first switch and the port 6′ of the second switch each is connected to a ground terminal FG and a leakage sensing terminal EPG.

The multi-functional ground fault interruption portion lights up the first upon the application of a normal power and energizes the relay coil CL to operate the first and second switches, so that their ports 6′ and 3′ each is connected to the ports 4′ and 8′ and then the load terminal E2 and the ground terminal E1 to apply the power to a load such as an electric device to be used.

The multi-functional ground fault interruption portion moves original positions from the ports 6′ and 3′ to the ports 7′ and 5′ respectively formed in the first and second switches when the leakage current are occurred at the leakage sensing terminal EPG due to the ground fault, in which the leakage currents are supplied to the rectification ports of the first bridge circuit to light up the first and second neon lamps connected in parallel to each other, apply rectified currents to both of the third resistor and the third resistor to light up the third neon lamp at the port 6′ and then drop a voltage as well as to get the main control portion to recognize a voltage of 0 ~ 10 volts.

The noise filter portion including a filter enables the main control portion to detect an overvoltage caused by the ground fault at a ground fault detection port G1 between a second condenser and a third condenser and then operate first and second switches of a relay in a ground fault interruption portion, so that the leakage currents are applied to the rectification ports of a first bridge circuit to light up first and second neon lamps connected in parallel to the output terminal of the multi-functional ground fault interruption portion along with also a third neon lamp at the port 6′ and but also to the fourth resistor to drop the voltage less than 10 volts.

The abnormal current sensing portion comprises first, second and third collecting portions, each of which is provided with a first coil and a first capacitor connected in parallel thereto, a second coil and a second capacitor connected in parallel thereto and a third coil and a third capacitor C3 connected in parallel thereto, and first, second and third compensation portions each connected in parallel to first, second and third collecting portions, in which the first collecting portion includes an input port connected to a third power port L3 that the power is applied thereto and passing through a fifth resistor to a fourth neon lamp and an output port passing through a neutral port N3 connected to the pulse width modulation control portion and passing through a fifth resistor connected to a fourth neon lamp and extended to the ground terminal FG, the second collecting portion includes an input port connected to the ground port of the neon fourth lamp and an output port connected in common to the pulse width modulation control portion and the ground terminal FG of the fourth neon lamp and an output port connected to the pulse width modulation control portion and connected to a leakage sensing terminal EPG that is connected to a load ground port E1, the third collecting portion includes an input port connected to a neutral port N4 and an output port connected in common to the pulse width modulation control portion and the ground terminal FG with a third diode being separated from the ground terminal FG of the fourth neon lamp. Therefore, the pules width modulation control portion detects leakage voltages and currents and compensates them through the pulse width modulation to be modulated into a power voltage of a certain amplitude. And then the mail control portion makes a potential difference from the normal power into “Zero Potentialization” to collect the leakage currents from the electric device to be uses around its surroundings and then to annihilate and shield them.

The first, second and third frequency compensating portions each comprises a conductor positioned on a printed circuit board substrate, a net having a higher conductivity and enclosing the surround portion of the conductor and a strong cylindrical permanent magnet positioned on the center portion of the net with its bottom surface contacted to the conductor and the net, each of which absorbs the leakage currents around its surroundings, collects them and applies them to the pulse width modulation control portion to modulate each frequency and phase, precisely, into “Zero Potentialization” and leads the main control portion to output a power of a normal frequency all the time.

The polarity indicating portion receives a leakage power from a ground fault detection port G1 accessed through a point A to a leakage sensing terminal EPG and the power L1 from the power terminal L and accessed through the output port 3 of the coil in the noise filter portion and then accessed through a point B and a neutral port N1 to the ground terminal FG of the third collecting portion, in which the power port L1 is connected to a point C and a point D is connected at the same time to the second collecting portion and the ground port of the fourth neon lamp, and comprises a fifth diode, a fourth LED and a seventh resistor connected in series between the points B and C, so that the leakage currents from a ground fault detection port G1 is applied through the fifth diode to the point B to turn on the fourth LED while the point B is connected to a normal power sensing portion, and a normal power sensing portion provided with a third bridge circuit having a power port connected to the point B to apply the normal power of the power port L1 thereto and an output port connected in turns to a parallel part of a fourth condenser and a fifth LED for indicating the application of the normal power and an eighth resistor, an abnormal voltage sensing port G2 for sensing an overvoltage connected from the power port L1 to the point C including a sixth diode, a sixth LED and a tenth resistor connected in series to turn on the sixth LED for indicating the abnormal power upon application of an overvoltage and/or a reverse voltage.

A multi-functional non-electric shock protection method comprises steps: upon power on, it is confirmed that a power terminal L, a neutral terminal N and a ground terminal FG are connected to a power; it is judged on the application of normal polarities and confirmed on the application of the normal power to start the control operation of a system; next, if the access of the normal polarities fails, it is judged whether another terminal is grounded upon the application of the power to the neutral terminal N or the ground terminal FG; then if the ground connection fails, a fifth LED is turned on and then the polarities of the power are changed in this case to control the operation of a multi-functional non-electric shock protection portion; it is judging whether the detection of a ground fault occurs and leakage currents are sensed in an electric device on power on; if first, second and third collecting portions confirms the occurrence of their leakage current on power-on, it is judged whether an overvoltage exists, and if the application of the overvoltage is confirmed, it is judged whether the leakage voltage is below 10 volts and 5mA; otherwise if it is over 10 volts and 5mA and the ground connection fails, the power polarities are changed to control the operation of the multi-functional non-electric protection portion; on the contrary if the leakage voltage is below 10 volts and 5mA, a main control portion is switched into an operation monitoring function of “Zero Polarization” to collect the leakage currents and then into the overvoltage monitoring mode to collect noises and apply them to a pulse width modulation portion; and during being operated it is judged whether the normal operation is maintained, on an abnormal state, a short circuit interrupter on an electrical distribution board is operated, upon the normal operation the normal operation state is maintained.

### EFFECT OF INVENTION

The invention enables electric appliances to confirm the application of a normal power and maintain the ground state, so that leakage currents caused due to the exposure to various environments are collected, ground fault currents are shielded, absorbed and reduced to protect the non-electric shock, and also an external serge is blocked and an occurrence of an overvoltage is sensed to trip a short circuit interrupter on an electrical distribution board.

### BRIEF DESCRIPTION OF DRAWINGS

The brief description of the drawings explaining the invention is as follows:

FIG. 1 is a block diagram showing a ground-type non-electric shock preventing apparatus according to a prior art;

FIG. 2 is a block diagram showing a multi-functional non-electric shock protection system comprising a multi-functional ground fault interruption portion and a multi-functional non-electric shock protection portion according to the invention;

FIG. 3 is a detailed circuit showing a block diagram of the multi-functional ground fault interruption portion according to the invention;

FIGS. 4a and 4b are detailed circuits showing each of a noise filter portion and a polarity indicating portion according to the invention;

FIG. 4c is a combination view showing a front portion and a perspective portion of a frequency compensation portion according to the invention; and,

FIG. 5 is a flow chart showing steps of a sequence based on the control operation of the multi-functional ground fault interruption portion and the multi-functional non-electric shock protection portion according to the invention

### EMBODIMENT OF INVENTION

According to the invention, a multi-functional non-electric shock protection system and method thereof applies and adapts a frequency modulation theory published by Edwin Howard Armstrong as Title “A Method of Reducing Disturbances in Radio Signaling by a System of Frequency Modulation”

Herein, applying the frequency modulation theory, a modulation compensation control device is materialized to make frequencies into a sinusoidal band utilizing a wave band based on an equal electric potential phenomenon of each phase interval (single phase, three phases). As shown in Diagram (1) of a frequency modulation compensation principle, the compensation of a frequency into a sinusoidal band transforms the frequency into a certain amplitude to arrange electric force lines without outside interferences to an electric potential difference. Therefore, the surge protection against an overvoltage occurred at the time of the power supplying to the inputting portion is possible, the adaption of the principle of almost shielding, extinguishing and incinerating earth fault leakage currents and leakage currents of the electric device used enables not only the prevention of various electric-shock accidents due to a humidity or water on human bodies from electric products but also the prevention of an electric fire accident upon combining of an arc sensor in a limited case that a ground wire in the products is installed.

Furthermore, according to the invention, if a sufficient leakage current amount is not secured on a print circuit board, as shown in Diagram 2, a positive charge of a leakage current prevails on its surround to concentrate the electric force lines between a terminal R and a metal plate (Conductor). At that time, the conductor becomes a negative charge, and vice versa.

Frequency Modulation Compensation Principal Explanation Drawings

(1) Coil Compensation [image] (2) Conductor Compensation

[image]

Therefore, the invention varies a frequency based on an electric signal in the continuation of a certain amplitude to keep the amplitude, consistently, without an exterior interference, so that noises and electro waves are removed and keeping the constant amplitude customizes into a certain amplitude, consistently, even under the influence of its surroundings to remove the noises.

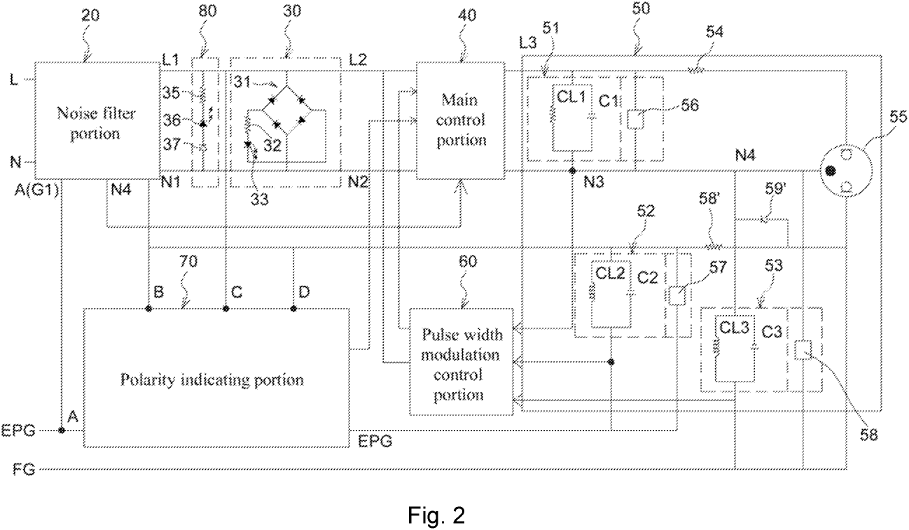

As shown in FIG. 2, according to the invention, a multi-functional non-electric shock protection system and method thereof comprises a multi-functional ground fault interruption portion 10 performing the ground fault current shield and the ground distribution and a multi-functional non-electric shock protection portion 90 preventing an electric shock accident by shielding, absorbing(annihilation) and reducing a leakage current and preventing the outside serge and the occurrence of an overvoltage.

the multi-functional ground fault interruption portion 10 and the multi-function non-electric shock protection portion 90 both are connected in common to outside input terminals of three phase input ones such as a power terminal of R phase, a neutral phase of N one and a ground phase of G one and complemented between each other so that it does the non-electric shock operation.

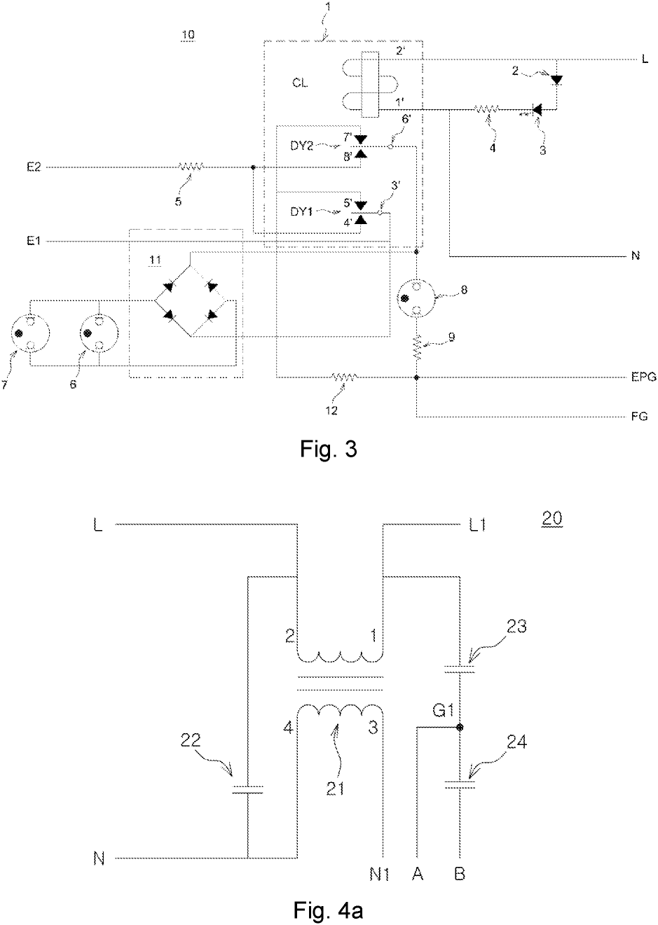

As shown in FIG. 3, the multi-functional ground fault interruption portion 10 includes a relay 1, a power terminal L connected to a port 2′ of a relay coil CL, to a port 1′ of which a first diode 2, a first LED 3 and a first resistor 4 are connected in series and a neutral terminal N connected between the first resistor 4 and a relay coil CL. The relay 1 includes a first switch DY1 and a second switch DY2, ports 4′ and 8′ of which are connected through a second resistor 5 in common to a load terminal E2. A first bridge circuit 11 includes rectification input ports each connected to the port 3′ of the first switch DY1 and the port 6′ of the second switch DY2 and output ports connected to a first neon lamp 6 and a second neon lamp 7 arranged in parallel. The port 3′ of the first switch DY1 is connected to a ground terminal E1, and the port 6′ of the second switch DY2 is connected to a third neon lamp 8 and a fourth resistor 9 to a ground terminal FG and a leakage sensing terminal EPG.

Therefore, the multi-functional ground fault interruption portion 10 lights up the first LED 3 upon the application of a normal power and energizes the relay coil CL to operate the first and second switches DY1 and DY2, so that their ports 6′ and 3′ each is connected to the ports 4′ and 8′ and then the load terminal E2 and the ground terminal E1 to apply a power source to a load such as an electric device (not shown) to be used.

The multi-functional ground fault interruption portion 10 moves the original positions from the ports 6′ and 3′ to the ports 7′ and 5′ respectively formed in the first and second switch DY1 and DY2, when leakage currents are occurred at the leakage sensing terminal EPG due to a ground fault. Then the leakage current is supplied to the rectification ports of the first bridge circuit 11 to light up the first and second neon lamps 6 and 7 connected in parallel to each other and then apply rectified voltage to the third resistor 12 to light up the third neon lamp 8 at the port 6′ and apply it to the third resistor 9 to drop a voltage. And then the main control portion 40 recognizes the leakage current below a voltage of 0 ~ 10V as described in detail thereafter.

As shown in FIG. 2, explaining the configuration, the multi-functional non-electric shock protection portion 90 comprises a noise filter portion 20 connected to both of the power terminal K and the neutral terminal for shielding, absorbing and reducing the leakage current, a power portion 30 for supplying a power source of a system, the main control portion 40 controlling respective portions of the system to output a normal power source thereby to keep an amount of a leakage current within 5mA even in any situation, an abnormal current sensing portion 50 for collecting a leakage current and a noise current and then converting into a normal power if the main control portion 40 detects an abnormal current, a pulse width modulation control portion 60 for width-modulating an amplitude and frequency of the power source from the abnormal current sensing portion 50 thereby to compensate the power source from the abnormal detection portion 60 and a polarity indicating portion 70 for detecting/indicating a polarity error of an inputting power.

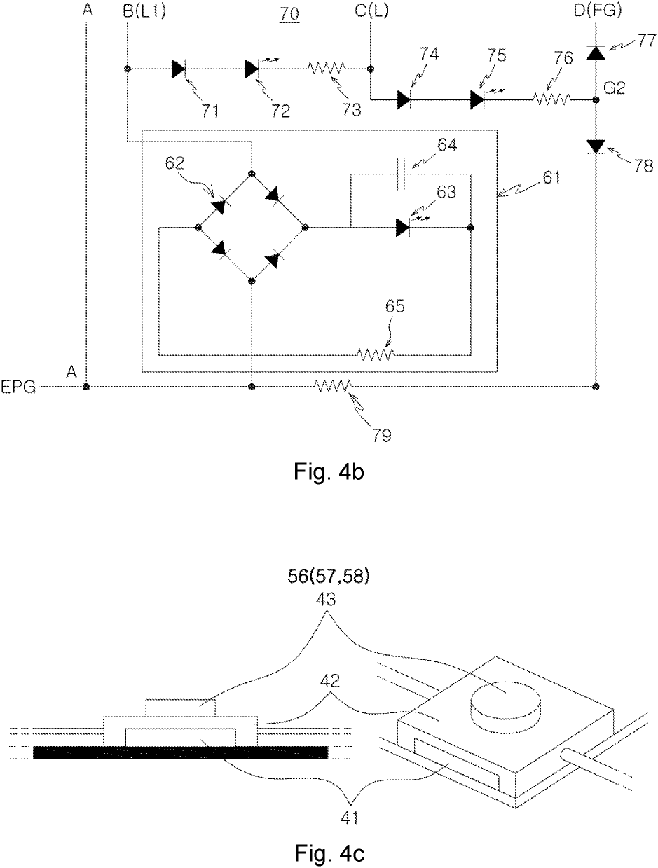

In more detail, as shown in FIG. 4a, a noise filter portion 20 comprises a filter 21 including a port 2 connected to the power terminal L and through a first condenser 22 to the neutral terminal N, a port 4 connected to the neutral terminal N, a port 1 passing through a fifth resistor 54 of an abnormal current sensing portion 50 to be connected to a fourth neon lamp 55 and then passing through a second condenser 23 and a third condenser 24 to be connected to a polarity indicating portion 70 and the neutral terminal N as described in detail later and a port 3 connected to the neutral terminal N4.

Therefore, the noise filter portion 20 not only removes ripple noises of power voltages on respective phases but also detects leakage currents due to the occurrence of a ground fault at a ground fault detection port G1 and then introduces them into the neutral terminal N4, so that the main control portion 40 gets a ground fault voltage applied thereto to be less than 10 volts through the zero electric potential operation caused by “Zero Potentialization”.

In other words, the noise filter portion 20 enables the main control portion 40 to detect an overvoltage resulting from the ground fault occurred at a ground fault detection port G1 between a second condenser 23 and a third condenser 24 and then operate a first switch DY1 and a second switch DY2 of a relay 1 in a ground fault interruption portion 10. Then, the leakage currents are applied to the rectification ports of a first bridge circuit 11 to light up not only first and second neon lamps 6 and 7 connected in parallel to the output terminals of a multi-functional ground fault interruption portion 10 but also a third lamp 8 at the port 6′, while it is applied to a fourth resistor 9 to drop the voltage less than 10 volts.

As shown in FIG. 2, a power portion 30 comprises a second bridge circuit 31, one port of a rectifying portion of which is connected to a power port L2 and other port of which is connected to both of the ground terminal FG and a function neutral port N2 in order to apply a power to the main control portion 40 and the pulse width modulation control portion 60, and a middle port of which is connected to a sixth resistor 32 and a second LED 33 in order to turn on a second LED 33 upon application of a normal power thereto.

An abnormal indicating portion 80 includes a seventh resistor 35, a third LED 36 and a second diode 37 positioned in a reverse direction in turns on the straight line between a power port L1 and a neutral port N1, so that the third LED 36 is turned on when an abnormal power is applied to the neutral terminal N.

An abnormal current sensing portion 50 comprises first, second, and third collecting portions 51, 52, and 53 characterized by the invention, each of which is provided with a first coil CL1 and a first capacitor C1 connected in parallel thereto, a second coil CL2 and a second capacitor C2 connected in parallel thereto and a third coil CL3 and a third capacitor C3 connected in parallel thereto. The first collecting portion 51 has an input port connected to a third power port L3 to which the power is applied and an output part passing through a neutral port N3 connected to the pulse width modulation portion 60. Also, the first collecting portion 51 includes an input port connected to a third power port L3 and passing through a fifth resistor 54 to the fourth neon lamp 55. The second collecting portion 52 includes an input port passing through an eighth resistor 58′ connected to the ground terminal FG of the neon fourth lamp 55 and an output port connected to the pulse width modulation control portion 60 and the leakage sensing terminal EPG. The third collecting portion 53 includes an input port connected to a neutral port N4 and an output port connected in common to the pulse width modulation control portion 60 and the ground terminal FG with a third diode 59′ being separated from the ground terminal FG of the fourth neon lamp 55.

Herein, it is noted that these collecting portions 51, 52 and 53 are individually connected side by side among the power terminal L, the neutral terminal N and the ground terminal FG, so that voltages and leakage currents leaked from the ground terminal FG in case of for example a power voltage 220V, is collected to be less than a voltage of 0~ 10V and a current of 0 ~ 500mA, and further the leakage current is kept less than 5mA. And then the pulse width modulation control portion 60 detects leakage voltages and currents to compensate them in respective phases through the pulse width modulation and convert them into ones of a certain amplitude as shown in Diagram 1.

Thereafter, the main control portion 40 process a phase difference of a normal power to be transformed into “Zero Potentialization”, so that the leakage currents from electric devices used around its peripheral and occurred due to the ground fault in itself are collected and then extinguished and cut off at the fourth neon lamp 55.

Furthermore, the first, second and third collecting portions 51, 52, 53 each includes first, second and third frequency compensating portions 56, 57, 58 connected in parallel thereto to collect/compensate for leakage currents introduced into the power terminal and the neutral terminal, if an amount of a leakage current collected is not enough. The first, second and third frequency compensating portions 56, 57, 58 absorbs leakage currents, for example electromagnetic waves, noises, etc. around its peripheral under the influence of a magnetic field as shown in Drawing 2, and then makes a flat coil collect them and apply them to the pulse width modulation portion 60 in order to modulate a frequency and phase with precision and make the phase difference into “Zero Potentialization”, so that the main control portion 4 controls itself to output the power having a normal frequency.

As shown in FIG. 4c, the first, second and third frequency compensating portions 56, 57, 58 each includes a conductor 41 positioned on a printed circuit board substrate, a net 42 having a higher conductivity and enclosing the surround portion of the conductor 41 and a stronger cylindrical permanent magnet 43 positioned on the center portion of the net 42 with its bottom surface contacted to the conductor 41 and the net 42.

Also, the abnormal current detection portion 50 blocks off various noises of frequency bands of 150Khz ~ 1Ghz introduced into lines from a system beforehand and makes the main control portion 40 recognize an outside signal on the lines in order not to enter into a primary line. Therefore, an electric force line is not short-circuited into an equipotential potential, and there is no the influence of third, fifth, seventh harmonic waves and the influence of second, fourth and sixth harmonic waves on communication lines, so that an inner line signal in an appliance electric device is not distorted.

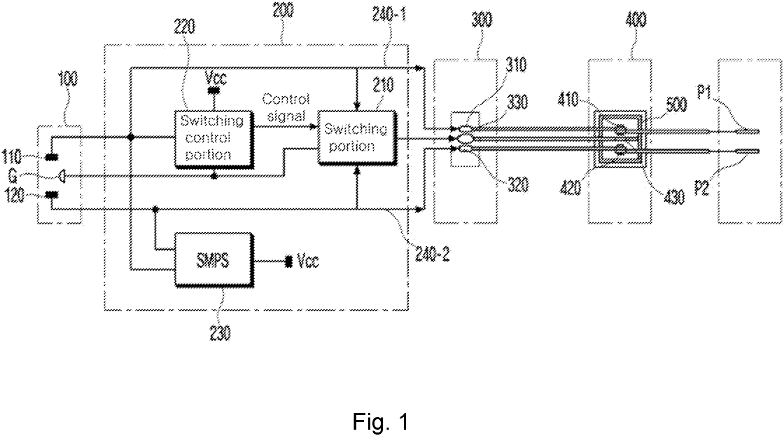

As shown in FIG. 4b, a polarity indicating portion 70 receives a leakage power from the ground fault detection port G1, which is accessed passing through a point A to the leakage sensing terminal EPG and the power L1 from the power terminal L, which is applied passing through the output port 3 of the coil 21 in the noise filter portion 20 and points B and D to the input port of the second collecting portion 52. The power port L1 is connected to a point C, and a point D is connected to the third collecting portion 53 and the ground port of the fourth neon lamp 55 at the same time (referring to FIG. 1).

Therefore, a fifth diode 71, a fourth LED 72 and a seventh resistor 73 are connected in series between the points B and C. The leakage currents from the ground fault detection port G1 are applied through the fifth diode 71 to the point B to turn on a fourth LED 72 while the point B is connected to a normal power sensing portion 61. The normal power sensing portion 61 includes a third bridge circuit 62 having a power port connected to the point B to apply the normal power of the power port L1 thereto and an output port connected in turns to a parallel part of a fourth condenser 64 and a fifth LED 63 and an eighth resistor 65. Herein, the fifth LED 63 indicates the application of the normal power.

On the other hand, an abnormal overvoltage appeared at the point C or the output of the seventh resistor 73 is sensed at an abnormal voltage sensing port G2 through a sixth diode 74, a sixth LED 75 and a tenth resistor 76 connected in series to each another. The abnormal voltage sensing port G2 is positioned at the middle portion of first and second voltage drop diodes 77 and 78 to be directed in an opposite direction to each other and connected through the ninth resistor 79 to the ground port of the fourth neon lamp 55 and the leakage sensing terminal EPG. Therefore, if the overvoltage or reverse voltage is applied to the abnormal voltage sensing port G2, the sixth LED 75 is turned on to indicate the application of the abnormal power.

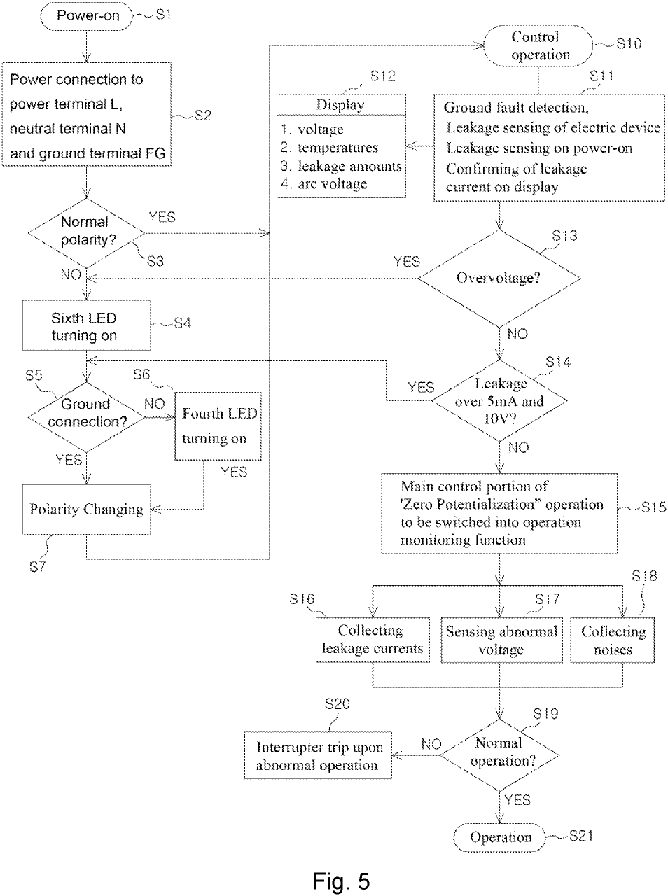

As shown in FIG. 5, according to the invention, a multi-functional non-electric shock protection method is operated in a manner to confirm the normal or abnormal voltage of a power supplied, which is described in detail as follows:

In order to operate a system, at step S1 a distribution board power of R phase, N phase and T phase each is connected to a power terminal L, a neutral terminal N and a ground terminal FG on power-on.

At step S2, the power application of the power terminal L, the neutral terminal N and the ground terminal FG is confirmed. At step S3 it is judged whether a polarity of the power applied is normal. If the application of the normal power is confirmed, step S3 moves to step 10 to control the operation of a system. If the normal polarity is not connected, step S3 moves to step S4 to confirm whether a sixth LED is turned on and goes onto step S5 to confirm the connection of the ground line. In other words, if the power is applied to the neutral N or the ground terminal FG, it is judged whether another terminal is grounded. If not grounded, step S5 moves to step S6 to confirm that the fourth LED 72 is turned on.

If the ground line is not connected at step S5 or the fourth LED 72 is lighted up at step S6, these steps move to step S7 to change/connect the power polarity to a normal position and then to step S10 to control the operation of the multi-function non-electric shock protection portion 90.

Thereafter, at step S11 a ground fault current is detected, a leakage current of an electronic appliance is sensed, a leakage current is sensed on power-on and the leakage current of first, second and third collecting portions is confirmed. Step 11 moves to step S12 to indicate 1. Voltage, 2. Temperature, 3. an amount of leakage current 4. an arc voltage on a display of its system not shown.

It is judged at step S13 whether an overvoltage is applied to the system. If the overvoltage is sensed, step S13 jumps back to step S4 to confirm on whether the sixth LED is turned on. Otherwise, step S13 moves to step S14 to judge whether the leakage voltage is below 10 volt and 5 mA.

At step S14, it is judged whether the leakage voltage is over 10 volts and 5mA. If so, step S14 jumps back to step S5 to confirm the connection of the ground line. If the leakage voltage is below 10 volt and 5mA, step S14 goes to step S15 that the main computer is shifted into the operation monitoring function to keep “Zero Polarization”. Thereafter, step S16, step 17 and step S18 are performed in turns to collect the leakage current, sense the abnormal voltage and collect the noise with being transformed into an arc detection mode thereby to apply the electromagnetic wave noise to a pulse width modulation control portion.

Thereafter, it is judged at step S 19 whether it is operating normally. Upon the abnormal operation, step 19 moves to step S20 to operate a short circuit interrupter on an electrical distribution board. Upon the normal operation, step S19 goes to step S21 to maintain the operation state.

### Explanation of Numbers

10: Multi-functional ground fault interruption portion 20: Noise filter portion
30: Power portion 40: Main control portion
50: Abnormal current sensing portion 60: Pulse width modulation control portion
70: Polarity indicating portion 80: Abnormal indicating portion
90: Multi-functional non-electric shock protection portion 1: Relay
6, 7, 8, 55: First, second, third and fourth neon lamp
51, 52, 53: First, second and third collecting portion 56, 57, 58: First, second and third frequency compensating portion

### INDUSTRIAL AVAILABILTY

The invention has various advantages in that electric shock accidents caused by leakage currents in industrial facilities can be prevented, and even in the event of flooding, an electric appliance is continuously operated without blocking supply currents thereby to prevent the second damage followed thereby.

Upon flooding of distribution boxes and/or agricultural facilities for streetlights and security lights electric shock accidents are prevented, and the trip phenomena of short circuit interrupters is forced to reduce and to prevent secondary damage.

1. A multi-functional non-electric shock protection system comprising:
a multi-functional ground fault interruption portion for detecting an abnormal state a power applied and performing a ground fault current shielding and ground distribution; and,
a multi-functional non-electric shock protection portion including a noise filter portion including a filter connected between a power terminal L and a neutral terminal N for shielding, absorbing(annihilating) and reducing a leakage current, a power portion supplying a power to a system, a main control portion controlling respective portions of the system to maintain an amount of leakage currents within 5mA in any situation in order to output a normal power, an abnormal current sensing portion for collecting the abnormal leakage currents and noise currents upon the abnormal current sensing of the main control portion as a use power, a pulse width modulation control portion for receiving a power from the abnormal current sensing portion and compensating the power through the amplitude and frequency modulation, and a polarity indicating portion for sensing a polarity error of an input power and indicating it, for capturing, shielding, absorbing and reducing leakage currents to prevent the non-electric shock on human beings and senses applied abnormal states and compensates frequencies in order to block an external serge, so that an electric device applied the power thereto and maintained into a ground state converts the frequency into a sinusoidal band with constant external interference-free amplitudes without interferences from various outside environments and makes electric power lines in an electro arrangement to be “Zero Potentialization” without any potential difference between each equipotential as well as prevent the formation of abnormal waveforms due to harmonious waves and noises.
.

2. The multi-functional ground fault interruption portion as claimed in claim 1 comprising; a relay including a relay coil and a first and second switches, in which the relay coil is connected at a port 2′ to a power terminal L and at a port 1′ to a neutral terminal N, a first diode, a first LED and a first resistor connected in series between port 1′ and port 2′, the relay including a first switch and a second switch, ports 4′ and 8′ of which are connected through a second resistor in common to a load terminal E2, a first bridge circuit including rectification input ports each connected to the port 3′ of the first switch and the port 6′ of the second switch and output ports connected to a first neon lamp and a second neon lamp arranged in parallel, and the port 3′ of the first switch and the port 6′ of the second switch each is connected to a ground terminal FG and a leakage sensing terminal EPG.

3. The multi-functional ground fault interruption portion as claimed in claim 1 comprising: a relay, a first bridge, a first LED and at least two neon lamps to light up the first LED upon the application of a normal power and energizes the relay coil CL to operate first and second switches of the relay, so that their ports 6′ and 3′ of the first and second switches each is connected to the ports 4′ and 8′ of the first and second switches and then the load terminal E2 and the ground terminal E1 to apply the power to a load to be used.

4. The noise filter portion as claimed in claim 1, comprising; a filter enabling the main control portion to detect an overvoltage caused by a ground fault at a ground fault detection port G1 between a second condenser and a third condenser and then operate first and second switches of the relay in the ground fault interruption portion, so that the leakage currents are applied not only to the rectification ports of the first bridge circuit to light up a first and second neon lamps connected in parallel to the output terminal of the multi-functional ground fault interruption portion along with the third neon lamp at the port 6′ and but also to the fourth resistor to drop the voltage less than 10 volts.

5. The abnormal current sensing portion as claimed in claim 1 comprising: first, second and third collecting portions, each of which is provided with a first coil and a first capacitor connected in parallel thereto, a second coil and a second capacitor connected in parallel thereto and a third coil and a third capacitor C3 connected in parallel thereto, in which the first collecting portion includes an input port connected to a third power port L3 that the power is applied thereto and through a fifth resistor to the fourth neon lamp and an output port connected through a neutral port N3 to the pulse width modulation control portion and through a fifth resistor connected to the fourth neon lamp and extended to the ground terminal FG, the second collecting portion includes an input port connected to the ground port of the neon fourth lamp and an output port connected in common to the pulse width modulation control portion and the ground terminal FG of the fourth neon lamp and an output port connected to the pulse width modulation control portion and connected to a leakage sensing terminal EPG that is connected to a load ground port E1, the third collecting portion includes an input port connected to the neutral port N4 and an output port connected in common to the pulse width modulation control portion and the ground terminal FG with a third diode being separated from the ground terminal FG of the fourth neon lamp, so that the pules width modulation control portion detects leakage voltages and currents and compensates them through the pulse width modulation to be converted into a power voltage of a certain amplitude, for enabling the main control portion to make a potential difference into “Zero Potentialization” leakage and for collecting leakage currents occurred due to the ground fault from the electric device to be used around its surroundings and making the fourth neon lamp absorb and shield them.

6. The first, second and third frequency compensating portions as claimed in claim 5, each comprising: a conductor positioned on a printed circuit board substrate, a net having a higher conductivity and enclosing the surround portion of the conductor and a strong cylindrical permanent magnet positioned on the center portion of the net with its bottom surface contacted to the conductor and the net, each of which absorbs the leakage currents around its surroundings, collects them and applies them to the pulse width modulation control portion to modulate each frequency and phase, precisely, into “Zero Potentialization” and leads the main control portion to output a power of a normal frequency all the time.

7. The polarity indicating portion as claimed in claim 1, comprising; a fifth diode, a fourth LED and a seventh resistor connected in series between the points B and C for receiving a leakage power from the ground fault detection port G1 accessed through a point A to a leakage sensing terminal EPG and the power L1 from the power terminal L and accessed through the output port 3 of the coil in the noise filter portion and then accessed through a point B and a neutral port N1 to the ground terminal FG of the third collecting portion, and further a sixth diode, a sixth LED and a tenth resistor connected in series between points C and D, in which the power port L1 is connected to the point C and the point D is connected at the same time to the second collecting portion and the ground port of the fourth neon lamp, so that the leakage currents from the ground fault detection port G1 is applied through the fifth diode to the point B to turn on the fourth LED while the point B is connected to a normal power sensing portion, and the normal power sensing portion including a third bridge circuit having a power port connected to the point B to apply the normal power of the power port L1 thereto and an output port connected in turns to a parallel part of a fourth condenser and a fifth LED for indicating the application of the normal power and an eighth resistor, so that the overvoltage and/or reverse voltage accessed from the power port L1 to the point C is applied to the abnormal voltage sensing port G2 to turn on the sixth LED for indicating the abnormal power upon application of an overvoltage and/or a reverse voltage.

8. A multi-functional non-electric shock protection method comprising steps:
confirming whether a power terminal L, a neutral terminal N and a ground terminal FG are connected to a power upon power on, then judging on the application of the normal polarities, confirming on the application of the normal power and performing the control operation of a system;
confirming the ground connection if the normal polarity is not connected, judging whether another terminal is grounded upon the application of the power to the neutral terminal N or the ground terminal FG, turning on a fifth LED if the ground connection fails and changing the polarities of the power to control the operation of a multi-functional non-electric shock protection portion;
changing the polarities of the power in case of the ground fault being detected and leakage currents being sensed if the access of the normal polarities fails, and checking first, second and third collecting portions whether their leakage current occurs on power-on and judging whether an overvoltage exists;
judging whether the values of the leakage voltage and current are below predetermined ones on the confirmation of the application of the overvoltage, changing the power polarity to control the operation of the multi-functional non-electric protection portion if the voltage and current values are more than predetermined ones and the ground connection fails;
switching the main control portion into an operation monitoring function of “Zero Polarization”, the overvoltage monitoring mode and an arc monitoring mode in turns to collect the leakage currents and noises and apply them to the pulse width modulation portion if the leakage voltage and current is below predetermined values; and,
judging whether the operation is normal, and operating a short circuit interrupter on an electrical distribution board to cut off the power on an abnormal state, otherwise maintaining the normal operation state upon the normal operation.
